(19) United States
(12) Patent Application Publication
(10) Pub. No.: US 2021/0104000 A1
(43) Pub. Date: Apr. 8, 2021

(54) SYSTEM AND METHOD FOR DYNAMICALLY GENERATING CUSTOMIZED EDUCATIONAL MATERIALS USING HEURISTIC AND NATURAL LANGUAGE PROCESSING ALGORITHMS

(71) Applicants: Amber Tomer, (US); Clint Tomer, (US)

(72) Inventor: Rex Franklin Tomer, Benton, IL (US)

(21) Appl. No.: 17/127,362

(22) Filed: Dec. 18, 2020

Related U.S. Application Data
(63) Continuation of application No. 14/067,687, filed on Oct. 30, 2013, now abandoned.

(51) Int. Cl. G06Q 50/20; G06Q 10/00

(52) U.S. Cl. CPC G06Q 50/20; G06Q 10/00

(57) ABSTRACT

A computing device for dynamically generating customized educational materials using heuristic and natural language processing algorithms is provided. The computing device is configured to receive a first set of educational content including a plurality of educational questions and a plurality of educational answers, generate a first set of educational content metadata by applying natural language processing algorithms and/or heuristic algorithms to the first set of educational content, and store the first set of educational content metadata and the first set of educational content within a memory device. The computing device is also configured to receive a set of parameters including a format parameter for generating an output format of a plurality of educational materials, generate a filter based on the set of parameters, and generate the plurality of educational materials using the second set of educational content including generating at least one game board based on the format parameter.

### CROSS REFERENCE TO RELATED APPLICATIONS

This application is a continuation application of U.S. patent application Ser. No. 14/067,687, filed Oct. 30, 2013, entitled “SYSTEM AND METHOD FOR GENERATING EDUCATIONAL MATERIALS”, the disclosure of which is incorporated herein by reference in its entirety.

### BACKGROUND OF THE DISCLOSURE

The field of the disclosure relates generally to educational materials and, more specifically, a system and method for generating educational materials.

At least some known systems for providing educational content include systems of providing previously obtained educational instructional materials within defined formats. Educational settings may include learners with a wide variety of educational interests, abilities, and experiences. Particular forms of educational materials may be more suitable for some learners than others. Particular content included in educational materials may be more suitable for some learners than others. Accordingly, a system and method for presenting appropriate content to a variety of learners is desired.

### BRIEF DESCRIPTION OF THE DISCLOSURE

In one aspect, a computing device for dynamically generating customized educational materials using heuristic and natural language processing algorithms is provided. The computing device includes a processor and a memory device coupled to the processor. The computing device is configured to receive, from at least one of a database server, an educational content data file, and a client computing device, a first set of educational content including a plurality of educational questions and a plurality of educational answers. Each educational answer is associated with at least one of the plurality of educational questions. The computing device is also configured to generate a first set of educational content metadata by applying at least one of natural language processing algorithms and heuristic algorithms to the first set of educational content. The first set of educational content metadata includes a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content. The computing device is further configured to store the first set of educational content metadata within the memory device along with the first set of educational content, and receive, from at least one of the database server, the educational content data file, and the client computing device, a set of parameters including a format parameter for generating an output format of the plurality of educational materials.

In addition, the computing device is configured to generate a filter based on the set of parameters. The filter represents an algorithm used for parsing the first set of educational content to generate a second set of educational content, and the second set of educational content includes a second set of educational content metadata matching the set of parameters used to generate the filter. The computing device is also configured to generate the plurality of educational materials using the second set of educational content including generating at least one game board based on the format parameter.

In a further aspect, a computer-based method for dynamically generating customized educational materials using heuristic and natural language processing algorithms is provided. The method is performed by a computing device including a memory device and a processor coupled to the memory device. The method includes receiving, from at least one of a database server, an educational content data file, and a client computing device, a first set of educational content including a plurality of educational questions and a plurality of educational answers. Each educational answer is associated with at least one of the plurality of educational questions. The method also includes generating a first set of educational content metadata by applying at least one of natural language processing algorithms and heuristic algorithms to the first set of educational content. The first set of educational content metadata includes a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content. The method further includes storing the first set of educational content metadata within the memory device along with the first set of educational content, and receiving, from at least one of the database server, the educational content data file, and the client computing device, a set of parameters including a format parameter for generating an output format of the plurality of educational materials.

In addition, the method includes generating a filter based on the set of parameters. The filter represents an algorithm used for parsing the first set of educational content to generate a second set of educational content, and the second set of educational content includes a second set of educational content metadata matching the set of parameters used to generate the filter. The method also includes generating the plurality of educational materials using the second set of educational content including generating at least one game board based on the format parameter.

In another aspect, one or more non-transitory computer-readable storage media for dynamically generating customized educational materials using heuristic and natural language processing algorithms is provided. The one or more non-transitory computer-readable storage media have computer-executable instructions embodied thereon. When executed by at least one computing device having a processor and a memory device coupled to the processor, the computer-executable instructions cause the at least one computing device to receive, from at least one of a database server, an educational content data file, and a client computing device, a first set of educational content including a plurality of educational questions and a plurality of educational answers. Each educational answer is associated with at least one of the plurality of educational questions. The computer-executable instructions also cause the at least one computing device to generate a first set of educational content metadata by applying at least one of natural language processing algorithms and heuristic algorithms to the first set of educational content. The first set of educational content metadata includes a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content. The computer-executable instructions further cause the at least one computing device to store the first set of educational content metadata within the memory device along with the first set of educational content, and receive, from at least one of the database server, the educational content data file, and the client computing device, a set of parameters including a format parameter for generating an output format of the plurality of educational materials.

In addition, the computer-executable instructions cause the at least one computing device to generate a filter based on the set of parameters. The filter represents an algorithm used for parsing the first set of educational content to generate a second set of educational content, and the second set of educational content includes a second set of educational content metadata matching the set of parameters used to generate the filter. The computer-executable instructions also cause the at least one computing device to generate the plurality of educational materials using the second set of educational content including generating at least one game board based on the format parameter.

### BRIEF DESCRIPTION OF THE DRAWINGS

The figures listed below show example embodiments of the methods and systems described herein.

FIG. 1 is a simplified block diagram of an example embodiment of a system for generating educational materials in accordance with one embodiment of the present disclosure.

FIG. 2 illustrates an example configuration of a client system shown in FIG. 1.

FIG. 3 illustrates an example configuration of a server system shown in FIG. 1.

FIG. 4 is a simplified flowchart illustrating the generation of educational materials using the system shown in FIG. 1.

FIG. 5 is a schematic diagram illustrating multiple systems generating educational materials using the system shown in FIG. 1.

FIG. 6 is an example illustration of a format for presenting educational materials generated by the system shown in FIG. 1.

FIG. 7 is an example illustration of a format for presenting educational materials generated by the system shown in FIG. 1 displayed on a mobile computing device displayed in FIG. 5.

FIGS. 8-23 are additional example illustrations of educational material generated by the system shown in FIG. 1.

FIG. 24 is a flowchart illustrating an example process utilized by the system shown in FIG. 1 for generating educational materials.

FIG. 25 is a diagram of components of one or more example computing devices that may be used in the environment shown in FIG. 5.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

This subject matter described herein relates generally to generating educational materials. A first set of educational content is received along with a set of parameters and is used to generate a second set of educational content and to further generate a plurality of educational materials using the second set of educational content. Specifically, the methods and systems described herein include receiving a first set of educational content, receiving a set of parameters, generating a second set of educational content by applying the set of parameters to the first set of educational content, and generating a plurality of educational materials using the second set of educational content.

As used herein, the terms “computer”, “computer system”, and “computing device” may be used interchangeably.

As used herein, “educational content” refers to information which may be used to facilitate the education of at least one learner. Also, as used herein, educational content includes at least one educational question associated with at least one educational answer. As such, educational content may be used to inform, test, and improve the knowledge of a learner in relation to one or more topics. For example, educational content may include a question related to a historical event and an answer responsive to the question. The educational content in this example would facilitate the education of the learner in at least the topic of history related to the educational question.

As used herein, “educational materials” refers to material generated based upon educational content to facilitate the education of at least one learner. Educational materials may include, without limitation, educational games, books, Bibles, tutorials, and any other material which may be generated based on educational content to facilitate the education of a learner. Although an example embodiment of the system and method described herein relates to the generation of educational games, other educational materials may be generated using the same system and method.

As used herein, “educational games” refer to an educational material generated based upon educational content and used to facilitate the education of at least one learner by incorporating an entertaining game. Educational games may include, without limitation, an educational form of bingo which may be played using paper or a computing device.

As used herein, a “bingo game” or “bingo-style game” refers to a method of gameplay substantially similar to the game of bingo. In a bingo game, as used herein, a card or a representation of a card is presented in a matrix layout and includes columns with labels including characters and cells with labels including characters. In the example embodiment, there are five rows and five columns. The columns have labels reading, “B”, “I”, “N”, “G”, and “O”, respectively. The cells have labels with numbers which vary for each individual participant in the bingo game. The bingo card also may include an educational question derived from educational content at one or more cells of the matrix. Alternately, the bingo game may have no educational questions in the cells. During gameplay, a cell number and column is identified by a facilitating educator. If a cell does not have an educational question listed, the facilitating educator will also read an educational question associated with the particular cell number and column. A player or learner will attempt to respond to the question. On successful response with a correct answer, the player will be able to mark the cell off. If a learner successfully achieves a particular pattern on the matrix before other learners achieve the pattern on their respective matrices, the player will win the game.

In the example system, a first set of educational content may be received at a computing device simultaneously or over a period of time. As described above, the first set of educational content received includes at least one educational question associated with at least one educational answer. In at least some examples, one educational question may be associated with multiple educational answers or vice versa. The first set of educational content may be received from an educational content database in communication with the computing device, from educational content data files stored at a memory device associated with the computing device, from a secondary computing device in communication with the computing device over a network, and through user input provided to the computing device. In a first example, the first set of educational content is used to generate educational materials to facilitate an educational game. More specifically, in the first example, the system is used by a teacher to create an educational history trivia game for a group of ten advanced learners ranging from the ages of twelve to fourteen. The style of the educational history trivia game is similar to a bingo game, as described below.

The first set of educational content received by the computing device may include educational content metadata related to the first set of educational content. As used herein, “educational content metadata,” refers to data which describes characteristics of the first set of educational content in the same manner that metadata describes data. For example, educational content metadata may include, without limitation, a difficulty rating associated with each educational question and each educational answer of the first set of educational content, a categorization associated with each educational question and each educational answer of the first set of educational content, an age level associated with each educational question and each educational answer of the first set of educational content, and a usage history associated with each educational question and each educational answer of the first set of educational content. In the first example, the first set of educational content may be most useful when it has educational content metadata which is relevant to the educational history trivia game. More specifically, the learners may be interested in educational questions and educational answers with a difficulty rating of “advanced,” a categorization of “history,” an age level of “twelve to fourteen,” and a usage history of “new.”

The computing device also receives a set of parameters. As used herein, “parameters” refer to characteristics, features, or factors which are applied to generate a second set of educational content. Parameters may be used to perform operations on the first set of educational content including editing, filtering, deleting, and generating educational questions and educational answers associated with the first set of educational content. Parameters may include, without limitation, a difficulty level, a grade level, a categorization level, a subject level, an age level, a usage history, a school week number, and a total number of users. By applying the parameters, the first set of educational content will be altered and organized to facilitate enhancing the set of educational questions and educational answers presented to at least one learner. In one example, the parameters applied may include a difficulty level of “advanced,” a categorization of “history,” an age level of “twelve to fourteen,” a usage history of “new,” and a total number of users of “ten.”

The computing device generates a second set of educational content by applying the set of parameters to the first set of educational content. The second set of educational content represents an altered and organized set of educational content which has been created based upon the parameters and the first set of educational content. In a first example, generating the second set of educational content may include creating a filter based upon the parameters. In the first example a filter would be created to filter for educational content which is matched to a difficulty level of “advanced,” a categorization of “history,” an age level of “twelve to fourteen,” and a usage history of “new.” The filter is used to generate filtered educational content by filtering the first set of educational content. The filtered educational content is selected based on the parameters and sorted into a second set of educational content. The second set of educational content represents a plurality of groups of the educational questions and a sorted set of the educational answers. Sorting the filtered educational content may also include sorting the sorted set of educational answers to facilitate gameplay. As described below, this represents sorting the educational answers so that they represent a variety of the plurality of groups of educational questions. In the first example, the educational answers are used to generate educational materials presented on a sheet (used by a teacher) while the educational questions are presented on cards similar to a bingo card (used by the learners). Each bingo-style card has a different group of questions from the other bingo-style cards. Accordingly, the sheet with the educational questions used by the teacher is ordered so that a variety of bingo-style cards are represented as the teacher moves through the list of questions in gameplay.

The computing device also generates a plurality of educational materials using the second set of educational questions. The educational materials are used to facilitate educating the learners. The educational materials may be generated in electronic forms and presented on, for example, computing devices such as mobile computing devices including tablet computing devices. Alternately, the educational materials may be generated in electronic forms and printed to a physical form such as paper. The format of the educational materials may be received at the computing device with the parameters or received separately. The educational materials may include, without limitation, a plurality of bingo-style educational cards based upon the plurality of groups of the educational questions, a sorted set of educational answers along with the associated educational questions, and supplementary educational material associated with the second set of educational content. The supplementary educational material may include, for example, without limitation, a workbook, a test, a homework assignment, a study guide, and a different game.

Described in detail herein are example embodiments of systems and methods for generating educational materials. The systems and methods facilitate, for example, receiving a first set of educational content, receiving a set of parameters, generating a second set of educational content by applying the set of parameters to the first set of educational content, and generating a plurality of educational materials using the second set of educational content. A technical effect of the systems and methods described herein include at least one of (a) facilitating the education of at least one learner by providing enhanced educational content; (b) improving the retention of information of the at least one learner through the generated supplementary materials; (c) reducing distractions in an educational setting by incorporating an entertaining activity with education; and (d) reducing the time required to instruct at least one learner on at least one educational topic.

More specifically, the technical effects can be achieved by performing at least one of the following steps: (a) receiving, at the memory device, a first set of educational content wherein the first set of educational content includes a plurality of educational questions and a plurality of educational answers wherein each educational answer is associated with at least one of the plurality of educational questions; (b) receiving, at the computing device, a set of parameters; (c) generating, at the computing device, a second set of educational content by applying the set of parameters to the first set of educational content; (d) generating a plurality of educational materials using the second set of educational content; (e) receiving the first set of educational content from at least one of an educational content database coupled to the computing device, educational content data files stored at the memory device, and input received through at least one input device coupled to the computing device; (f) receiving a first set of educational content metadata related to the first set of educational content, the first set of educational content metadata includes at least one of a difficulty rating associated with each educational question and each educational answer of the first set of educational content, a categorization associated with each educational question and each educational answer of the first set of educational content, an age level associated with each educational question and each educational answer of the first set of educational content, and a usage history associated with each educational question and each educational answer of the first set of educational content.

Alternately, or in combination, the technical effects may also be achieved by: (g) receiving a set of parameters further comprises receiving at least one of at least one difficulty level associated with the generated educational materials, at least one categorization associated with the generated educational materials, at least one age level associated with the generated educational materials, at least one usage history associated with the generated educational materials, and a total number of users associated with the generated educational materials; (h) generating a filter based upon the parameters; (i) generating filtered educational content by filtering the first set of educational content with the filter; (j) selecting, based on the parameters, the filtered educational content; (k) sorting the filtered educational content into the second set of educational content, wherein the second set of educational content represents a plurality of groups of the educational questions and a sorted set of the educational answers; (l) sorting the sorted set of educational answers such that the order of the sorted set of educational answers increases with respect to the plurality of groups of the educational questions; and (m) generating at least one of a plurality of educational cards based upon the plurality of groups of the educational questions, wherein the plurality of educational cards are formatted in a matrix layout, a sorted set of the educational answers and the associated educational questions, and supplementary educational material associated with the second set of educational content, wherein the supplementary educational material contains references associating educational questions to portions of the supplementary educational material.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, or to a relational database management system (RDBMS), or both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL®, IBM® DB2, Microsoft® SQL Server, Sybase®, and PostgreSQL. However, any database may be used that enables the systems and methods described herein. (Oracle and MySQL are registered trademarks of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.) As used herein, the term “database system” refers specifically to a RDBMS.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to generating educational materials.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

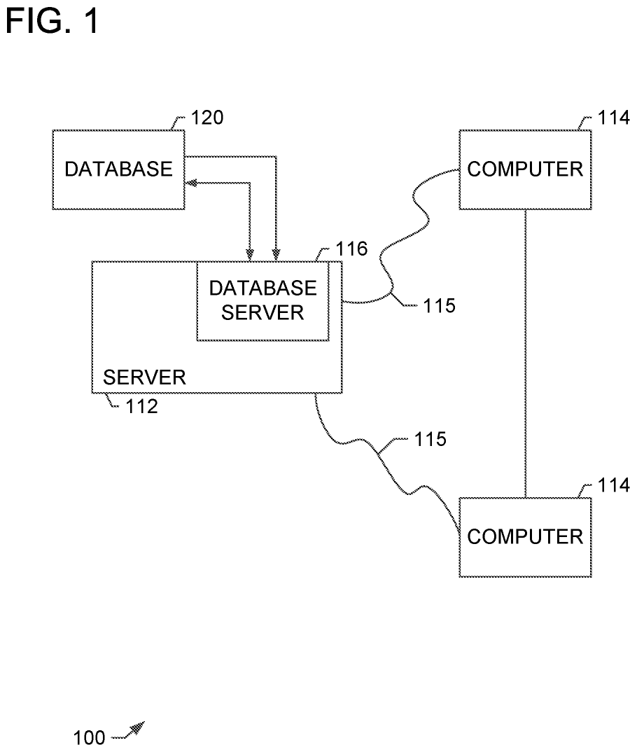

FIG. 1 is a simplified block diagram of an example system 100 for generating educational materials, including a plurality of computing devices in accordance with one embodiment of the present disclosure. More specifically, in the example embodiment, system 100 includes a server 112 and a plurality of client sub-systems, also referred to as “clients” 114, connected to server 112. In one embodiment, server 112 may be a computing server configured to perform the operations herein and may be referred to as a controller server. In one embodiment, clients 114 are computing devices communicatively coupled to server 112 through a network 115, such an such as a local area network (LAN) or a wide area network (WAN), dial-in-connections, cable modems, and special high-speed Integrated Services Digital Network (ISDN) lines, or the Internet. In the example embodiment, clients 114 may be associated with generating or receiving educational materials. For example, client 114 may contain educational questions and educational answers and provide them to server 112. Alternately, client 114 may receive educational materials from server 112. Clients 114 may therefore generate distinct educational content which is transferred to server 112 via network 115.

In the example embodiment, server 112 includes a database server 116 connected to database 120, which contains data stored in data sources which may be used to generate educational materials received by clients 114. In one embodiment, centralized database 120 is stored on server 112 and is accessed by potential users at one of clients 114 by logging onto server 112 through one of clients 114. In an alternative embodiment, database 120 is stored remotely from server 112.

Database 120 may include a single database having separated sections or partitions or may include multiple databases, each being separate from each other. Each of the multiple databases may have similar or distinct functional characteristics. Database 120 may store any data in data sources which may be used to generate educational materials as described herein including, without limitation, a first set of educational content, a set of parameters, a second set of parameters, a plurality of educational materials, and formats and algorithms used to generate the plurality of educational materials (none shown in FIG. 1).

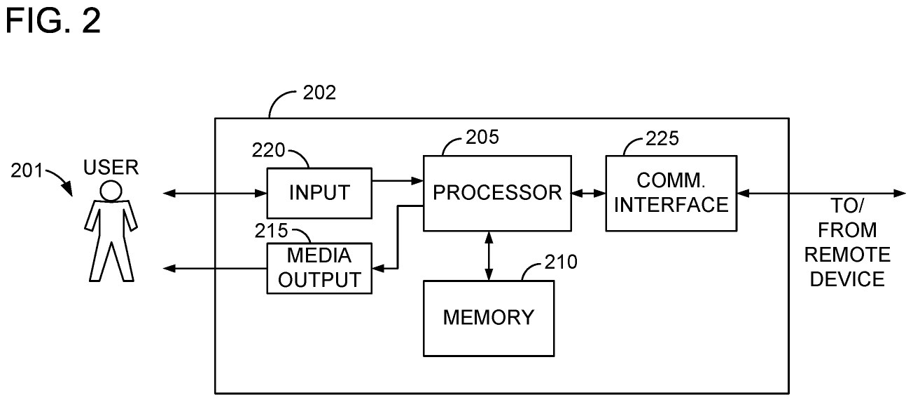

FIG. 2 illustrates an example configuration of a user system 202 operated by a user 201, such as a system administrator. User system 202 may include, but is not limited to, clients 114. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server 112. A client application allows user 201 to interact with a server application from server 112.

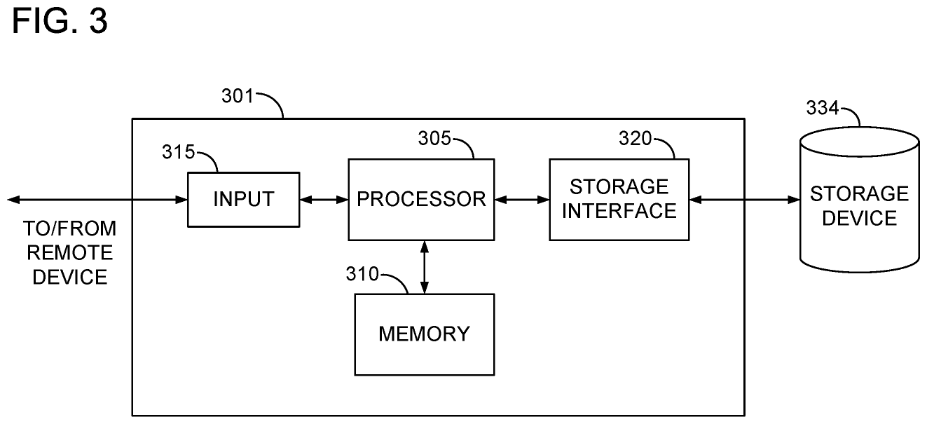

FIG. 3 illustrates an example configuration of a server system 301 such as server 112 (shown in FIG. 1). Server system 301 may include, but is not limited to, database server 116, a transaction server, a web server, a fax server, a directory server, and a mail server.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX®, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from clients 114 via network 115 (shown in FIG. 1) such as the Internet.

Processor 305 may also be operatively coupled to a storage device 334. Storage device 334 is any computer-operated hardware suitable for storing and/or retrieving data. In some embodiments, storage device 334 is integrated in server system 301. For example, server system 301 may include one or more hard disk drives as storage device 334. In other embodiments, storage device 334 is external to server system 301 and may be accessed by a plurality of server systems 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

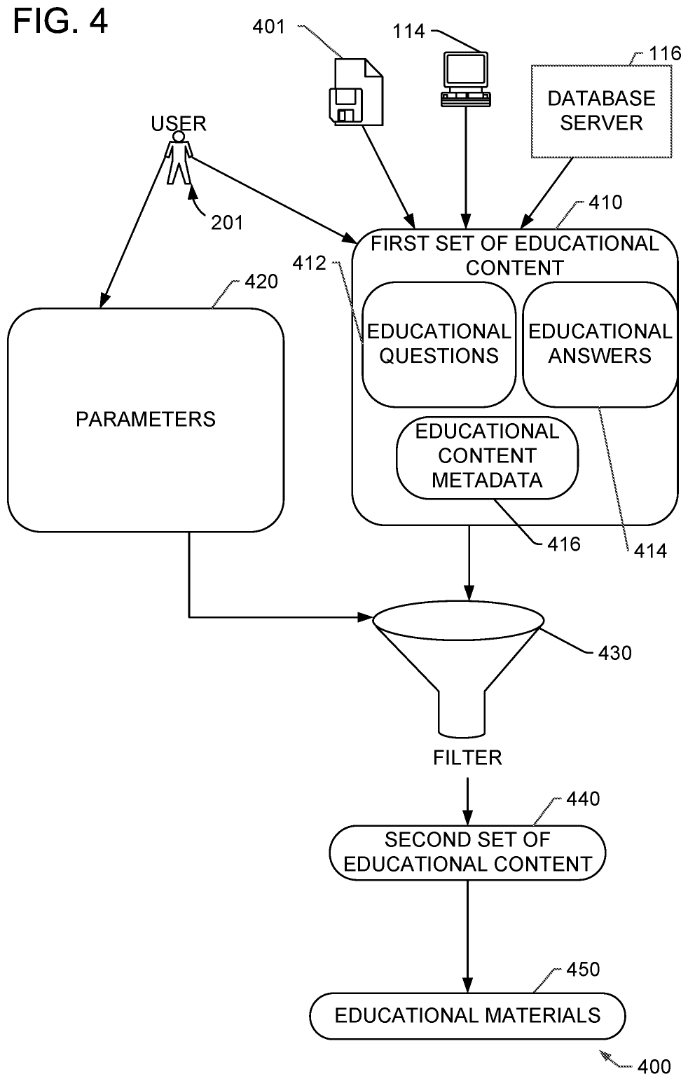

FIG. 4 is a simplified flowchart illustrating the generation of educational materials using server 112 (shown in FIG. 1). In flowchart 400, a first set of educational content 410 is received from at least one of user 201 providing input at server 112, at least one educational content data file 401 available to server 112, at least one client 114 in networked communication with server 112, and database server 116 in communication with server 112.

First set of educational content 410 represents data, such as a data file, used to generate educational materials 450. First set of educational content 410 may include, without limitation, a spreadsheet file, an XML file, a database record, a CSV file, a tab-delimited file, a word processing document file, and any other data which may be interpreted by server 112.

First set of educational content 410 includes educational questions 412 and educational answers 414. Each educational question 412 in first set of educational content 410 corresponds to at least one educational answer 414 in first set of educational content 410. First set of educational content 410 may include educational questions 412 and educational answers 414 from similar or varied educational topics, for a single age group or a variety of age groups, for advanced learners or introductory learners, and for a single language or a variety of languages. As such, first set of educational content 410 may be substantially homogeneous or heterogeneous. First set of educational content 410 may additionally be built over a period of time or be received at a single time. For example, first set of educational content 410 may be received from, for example, database server 116 at a particular moment in time. Alternately, first set of educational content 410 may be received piecemeal such that a portion is received at a point in time from educational content data file 401 and another portion is received at a different point in time from input from user 201. In the example embodiment, first set of educational content 410 incorporates data received from educational content data file 401, user 201, client 114, and database server 116.

First set of educational content 410 also includes educational content metadata 416. Educational content metadata 416 includes data describing the data contained in first set of educational content 410. Educational content metadata 416 includes, for example, information regarding the date and time that first set of educational content 410 was generated. Educational content metadata 416 also includes data describing educational questions 412 and educational answers 414. Educational content metadata 416 includes, for example, information regarding the date and time that each educational question 412 and each educational answer 414 were created. Educational content metadata 416 also includes, without limitation, difficulty ratings associated with each educational question 412 and each educational answer 414, categorizations associated with each educational question 412 and each educational answer 414, age levels associated with each educational question 412 and each educational answer 414, and usage history associated with each educational question 412 and each educational answer 414.

In the example embodiment, first set of educational content 410 also represents heterogeneous educational questions 412 and educational answers 414. A portion of first set of educational content 410 is represented in the table below:

TABLE 1

| Educational | Educational | Date/Time | | Difficulty | Age | Usage |
|---|---|---|---|---|---|---|
| Question | Answer | Created | Categorization | Rating | Level | History |
| What king | William the | Jan. 1, 1997 | History, & | Easy | 13-15 | John, |
| won in the | Conqueror | 3:05 PM | English | | | Mark, |
| Battle of | | | History | | | Stephen |
| Hastings? | | | | | | |
| What was | Edo | Mar. 14, 2003 | History, | Medium | 14-17 | Susan, |
| the previous | | 5:15 PM | World | | | Stephen, |
| name of | | | History, | | | Andrea |
| Tokyo? | | | Geography | | | |
| After it was | Dwarf | Jan. 15, 2009 | History, | Hard | 14-17 | New |
| delisted as a | planet or | 4:15 PM | Science, | | | |
| planet, what | plutoid | | Astronomy, & | | | |
| is Pluto's | | | Modern | | | |
| new | | | History | | | |
| designation? | | | | | | |
| What is the | Edo | Apr. 7, 2011 | History & | Hard | 15-18 | Andrea |
| name of the | | 4:13 PM | World | | | |
| period of | | | History | | | |
| Japanese | | | | | | |
| history | | | | | | |
| spanning | | | | | | |
| from 1603 | | | | | | |
| to 1868? | | | | | | |

Accordingly, first set of educational content 410 shown in Table 1 includes educational questions 412 and educational answers 414 with several different categorizations, difficulty ratings, age levels, usage levels, and dates and times of creation. Accordingly, educational content metadata 416 can vary significantly within first set of educational content 410. Also note that the third educational question 412 has two different educational answers 414 while the second and fourth educational question 412 have the same educational answer 414. Date/time of creation may represent the date/time each educational question 412 and educational answer 414 were created in an external system. Date/time of creation may also represent the date/time each educational question 412 and educational answer 414 were provided to server 112 to be included in first set of educational content 410. Educational content metadata 416 may also include a variety of categorizations. Educational content metadata 416 may include difficulty ratings based on any appropriate scale including for example, a scale including values of “easy,” “medium,” or “difficult”, or a scale including numerical values. Difficulty ratings may be generated based on an evaluation provided in the original input of first set of educational content 410. Alternately, difficulty ratings may be generated based upon the experiences of learners with educational materials 450 generated based on a particular educational question 412 and educational answer 414. Age levels may be generated in a similar fashion to difficulty ratings. Usage history represents an identification of whether learners have received educational questions 412 in previously generated educational materials 450. In the example of Table 1, Andrea has received the second and fourth question before while Stephen has received the first and second question before.

Educational content metadata 416 may be provided manually or programmatically. For example, natural language processing algorithms may be used to determine categorizations. Algorithms based on the system and method described herein may be used to determine the date/time created and the usage history. Difficulty ratings and educational answers may be determined based on heuristic algorithms or receiving and processing external data sources.

Flowchart 400 also includes receiving parameters 420 used to generate educational materials 450. More specifically, user 201 provides parameters 420 to server 112 to generate filter 430. Alternately, parameters 420 may be stored in memory device 310 (shown in FIG. 3) and received from memory device 310. Additionally, parameters 420 may be received from database server 116 or client 114. Parameters 420 may include, for example, at least one difficulty level associated with the generated educational materials 450, at least one categorization associated with the generated educational materials 450, at least one age level associated with the generated educational materials 450, at least one usage history associated with the generated educational materials 450, a total number of users associated with the generated educational materials 450, a listing of users receiving the generated educational materials 450, and a format of generated educational materials 450. Parameters 420 facilitate the selection of questions to present to particular learners. For example, a portion of parameters 420 used in the example embodiment is shown below:

TABLE 2

| | | | | Total | | |
|---|---|---|---|---|---|---|
| Difficulty | Categoriza- | Age | Usage | Number | Listing of | |
| Level | tion | Level | History | of Users | Users | Format |
| Hard | History | 14-17 | New | 2 | Andrea, | Bingo |
| | | | | | Stephen | |

Accordingly, in Table 2, the system and method are being used to generate educational materials 450 to facilitate an educational history trivia game with “Hard” questions for ages “14-17” where all users will see “new” questions for two players, Andrea and Stephen. The format of the game desired is a bingo-style game. Server 112 generates a filter 430 based on parameters 420. Filter 430 represents a program or algorithm used to select from first set of educational content 410. Filter 430 functionally parses first set of educational content 410 to determine whether each condition specified by filter 430 is satisfied. In at least some examples, filter 430 may rank criteria of parameters 420 and only apply some of parameters 420. For example, when first set of educational content 410 has a limited set of educational questions 412 responsive to a category selected in parameters 420 but parameters 420 specifies a game format requiring a larger number of educational questions 412, filter 430 may allow the selection of some educational questions 412 and educational answers 414 which do not correspond to all of filter 430.

In the example embodiment, by comparing Table 1 to Table 2, it is seen that only the third question of Table 1 will satisfy the conditions of Table 2. Since Table 1 represents a portion of first set of educational content 410, filter 430 will select for other educational questions 412 and educational answers 414.

First set of educational content 410 is filtered with filter 430 and then sorted into second set of educational content 440. Second set of educational content 440 represents educational questions 412 and educational answers 414 grouped based upon the amount of learners involved in the educational game. In the example embodiment two learners, Andrea and Stephen, are playing a bingo-style game. Accordingly, second set of educational content 440 represents a list of educational questions 412 and educational answers 414 that may be used to fill a bingo-style card. In the example embodiment, Andrea and Stephen will not receive educational answers 414 on their respective bingo-style games. Instead, associated educational answers 414 will be available to an educator facilitating the educational game. Second set of educational content 440 accordingly groups educational questions 412 into two groups. One group is for Stephen and one is for Andrea. In some examples, some portion of educational questions 412 may overlap between learners but are at different locations on their bingo-style cards as displayed on a bingo-style card, bingo-style sheet, and a virtual representation of a bingo-style card.

Second set of educational content 440 is used to generate educational materials 450. Specifically, second set of educational content 440 may be formatted and presented in a manner suitable to generate educational materials 450. Educational materials 450 may include, without limitation, educational games such as the bingo-style game described in the example embodiment and supplementary educational material associated with second set of educational content 440. Supplementary educational material may include, for example and without limitation, worksheets, tests, games, study guides, and work books. In the example embodiment, educational materials 450 generated represent the educational bingo-style game. More specifically, two bingo-style cards are presented to Stephen and Andrea with separate questions. A separate question and answer sheet is provided to a facilitating educator who may call numbers out from the question and answer sheet and read an associated question. In one example, educational materials 450 may be printed to a paper format. In an alternative example, educational materials 450 may be presented digitally on, for example, a mobile computing device such as a tablet computing device.

The example embodiment involves the generation of a bingo-style game. However, the methods and systems used herein may be used to generate a variety of alternative educational materials 450 including other educational games, tests, homework, and study guides.

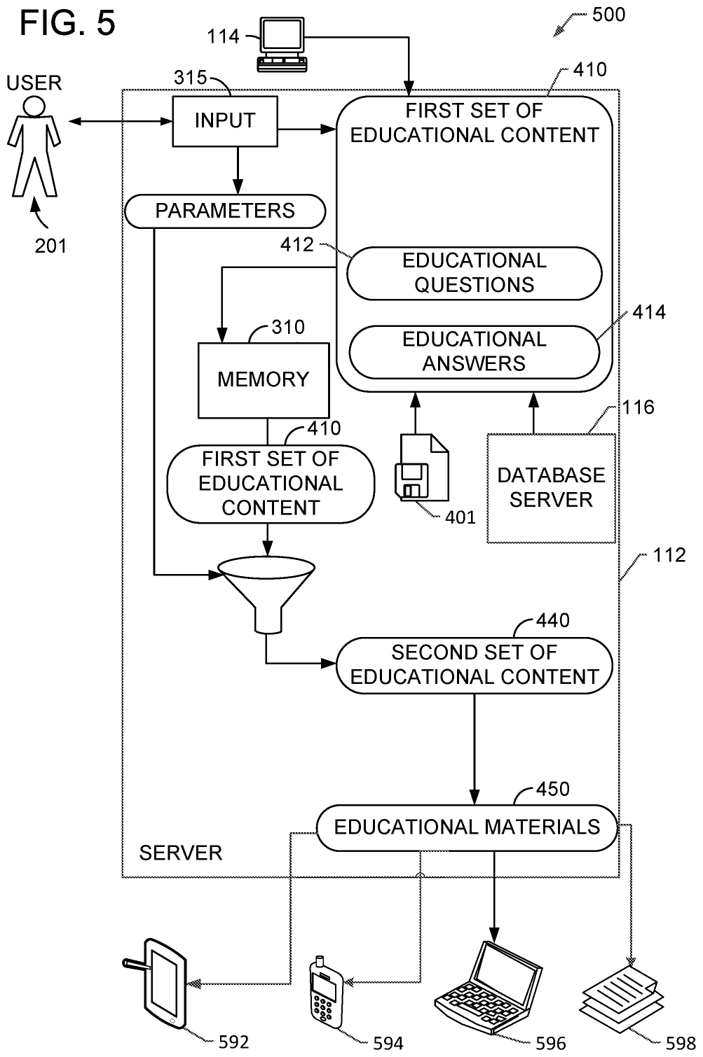

FIG. 5 is a schematic diagram illustrating an environment for generating educational materials 450 using server 112. In diagram 500, first set of educational content 410 is received by memory device 310. First set of educational content 410 includes educational questions 412 and educational answers 414. As shown in FIG. 4, first set of educational content 410 also includes educational content metadata 416. First set of educational content 410 is received from at least one of client 114, input provided by user 201 at input 315 and received at processor 205 (shown in FIG. 2), educational content data file 401, and database server 116.

Parameters 420 are also received at server 112 from user 201 using input 315. Parameters 420 are used to generate filter 430 which processes first set of educational content 410 into second set of educational content 440. Server 112 applies formatting programs to second set of educational content 440 to generate educational materials 450 for a plurality of learners. Educational materials 450 are presented in a plurality of formats 592, 594, 596, and 598. More specifically, educational materials 450 may be alternately presented on, for example, a mobile computing device such as tablet computing device 592, a mobile phone 594, a computing device including laptop computer 596, and/or printed to paper documents 598. Educational materials 450 presented on computing devices 592, 594, and 596 may be distributed using a network including a wireless network or through other methods of data transfer.

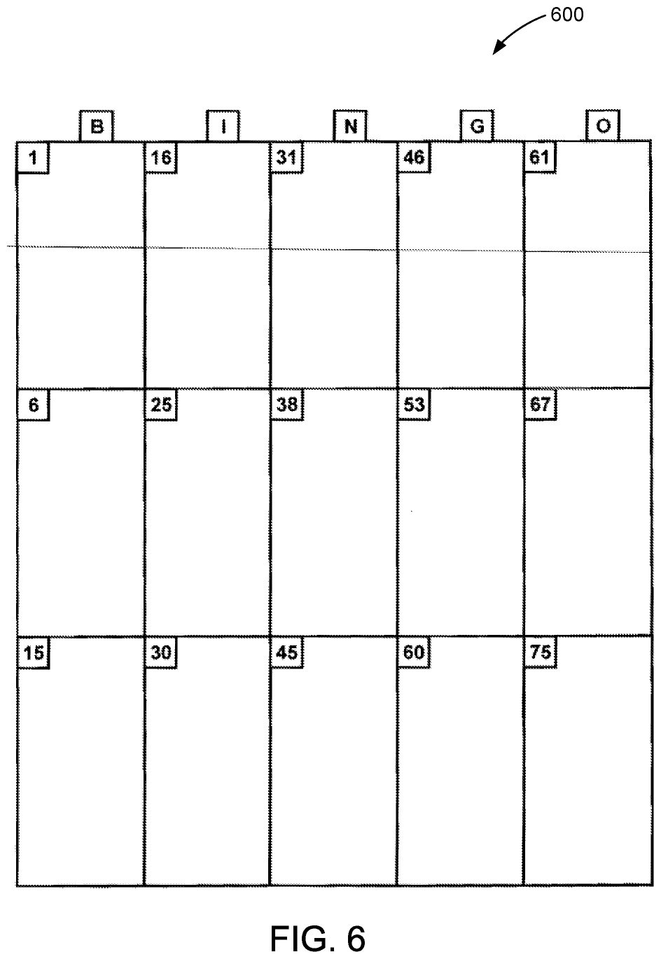

FIG. 6 is an example illustration 600 of a format for presenting educational materials 450 generated by the system 100 (shown in FIG. 1). Illustration 600 is a bingo-style card 600 that may be populated with educational materials 450. Using bingo-style card 600, a bingo-style game is played based upon first set of educational content 410. As described above, educational materials 450 may variously contain educational questions 412 (as shown in FIG. 4) or not. For each respective learner playing the bingo-style game, bingo-style card 600 will vary such that at least the listed cell numbers vary. In the example embodiment, a facilitating educator has a list of including bingo numbers including column identifiers and cell identifiers. For each bingo number, an educational question 412 and an educational answer 414 (shown in FIG. 4) is also provided to the facilitating educator. The facilitating educator may pick a particular bingo number and read an educational question 412. If a learner sees the bingo number on their bingo-style card 600 and can correctly identify an answer, the learner may mark off the bingo-style card 600 at the bingo number. For example, the learner may mark off the bingo-style card 600 by marking an “X” at the bingo number with a writing implement. Alternately, the learner may mark off the bingo-style card 600 using a token or a chip as a placeholder over the bingo number. If the learner successfully marks off bingo numbers to create a designated pattern such as a line on the bingo-style card 600 before any other learner achieves the designated pattern, the learner will win the game. In alternative embodiments, bingo-style card 600 will include associated educational questions 412 at each bingo number. In these embodiments, the facilitator is not required to read an educational question 412.

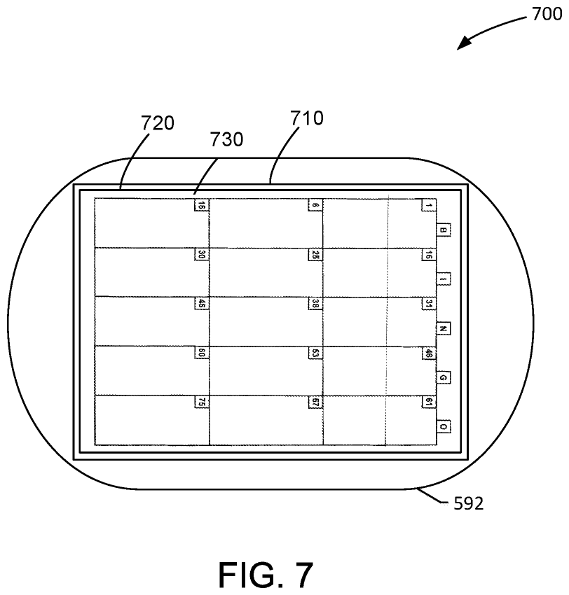

FIG. 7 is an example illustration 700 of a format for presenting educational materials 450 (shown in FIG. 4) generated by the system 100 (shown in FIG. 1) and displayed on a mobile computing device 592. Mobile computing device 592 includes a mobile computing screen 710. Mobile computing screen 710 is configured to receive input from a user such as user 201 (shown in FIG. 2) including haptic inputs and other tactile inputs. Mobile computing screen 710 is configured to display an application 720. Application 720 may be any application 720 capable of facilitating the systems and methods described herein. In the example embodiment, application 720 is a bingo-style game application 720. Bingo-style game application 720 presents a visual representation 730 of a bingo-style card such as bingo-style card 600 (shown in FIG. 6). Bingo-style game application 720 is configured to facilitate the playing of a bingo-style game. Bingo-style game application 720 may present educational questions 412 at each bingo number and receive learner input to answer educational questions 412 at each bingo number. In the example embodiment, Bingo-style game application 720 may also be used to verify the accuracy of an answer provided by a learner.

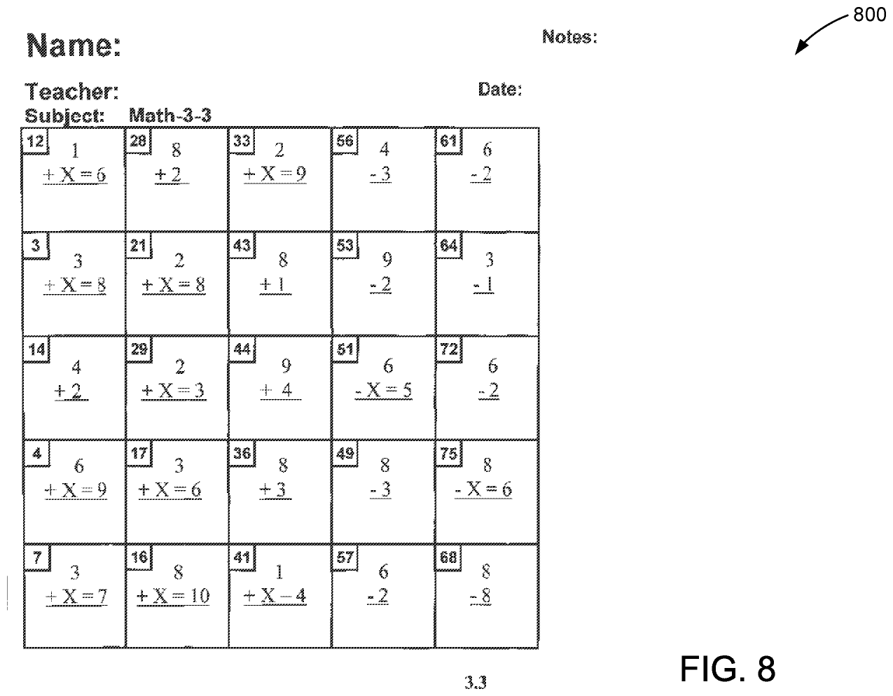

FIG. 8 is an example illustration 800 of educational material 450 (shown in FIG. 4) generated by system 100 (shown in FIG. 1). Illustration 800 is in the homework or test format where the teacher use the difference numbered squares to have the students fill in answers to the questions or in this case math problems. It also has a place for notes so the teacher can follow how the student come to their answers.

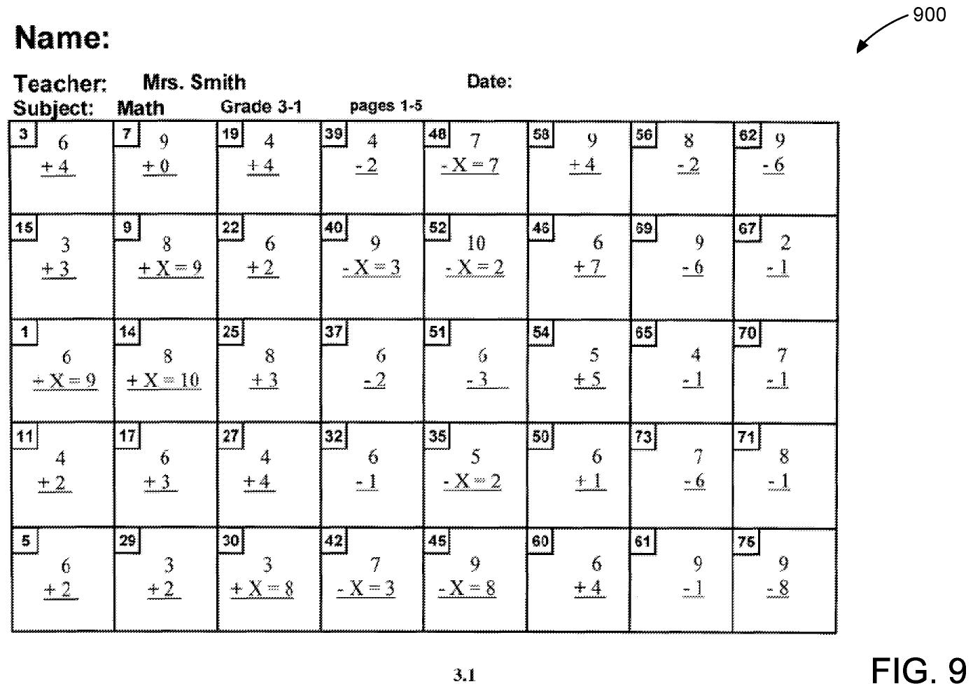

FIG. 9 is an example illustration 900 of educational material 450 (shown in FIG. 4) generated by system 100 (shown in FIG. 1). Illustration 900 is in the homework or test format where the teacher use the difference numbered squares to have the students fill in answers to the questions or in this case math problems. This example has more problems and therefore doesn't have any space for notes.

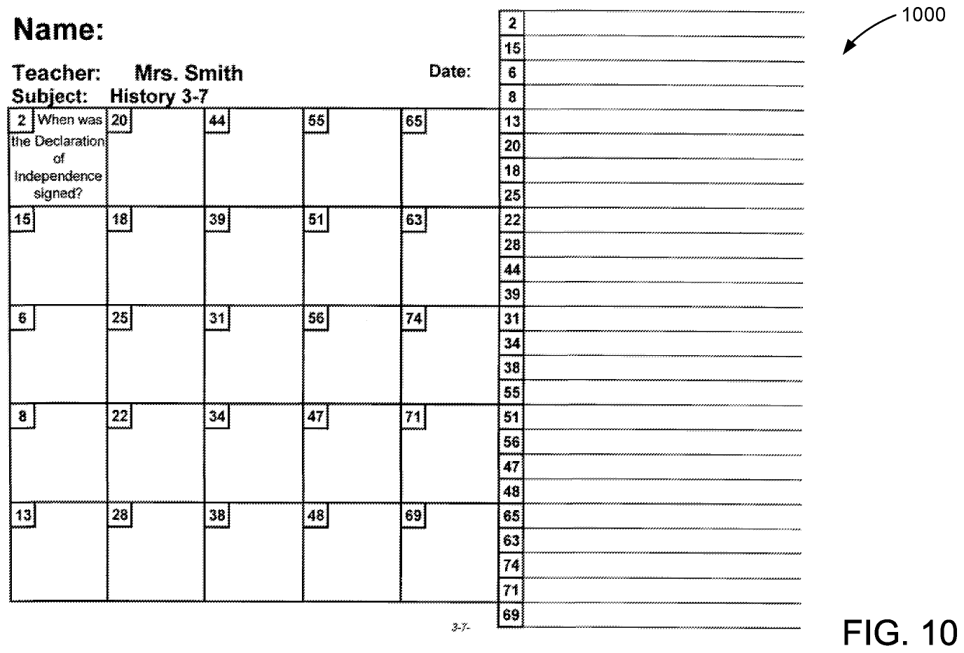

FIG. 10 is an example illustration 1000 of educational material 450 (shown in FIG. 4) generated by system 100 (shown in FIG. 1). Illustration 1000 is in the homework or test format where the teacher use the difference numbered squares to have the students fill in answers to the questions to the right side of the sheet.

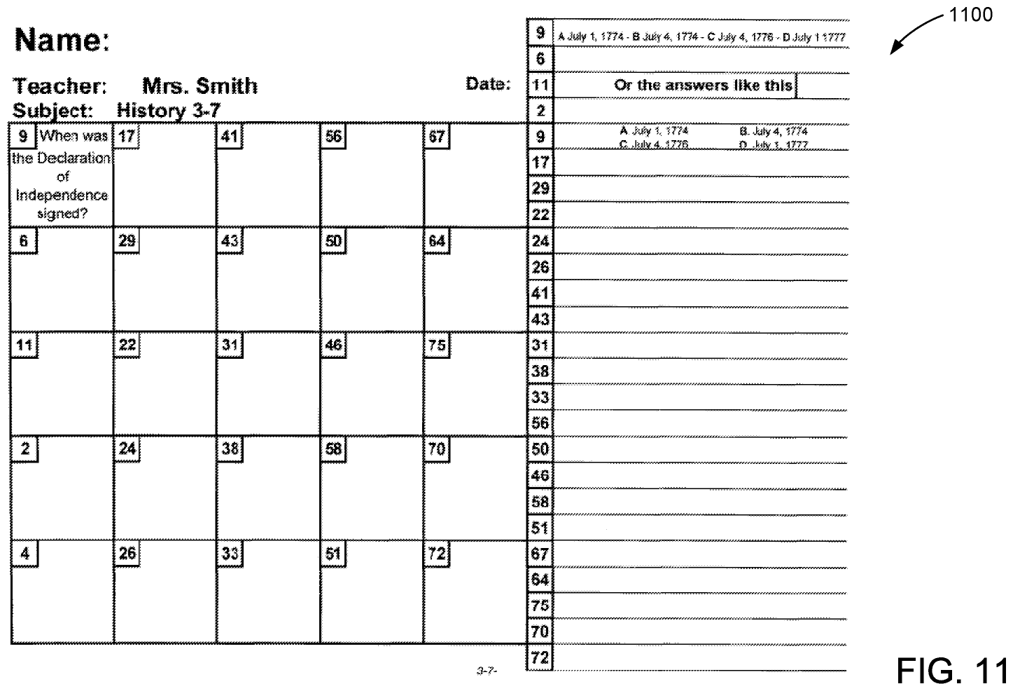

FIG. 11 is an example illustration 1100 of educational material 450 (shown in FIG. 4) generated by system 100 (shown in FIG. 1). Illustration 1100 is in the homework or test format where the teacher use the difference numbered squares to have the students circle the answer to the questions located at the right side of the sheet.

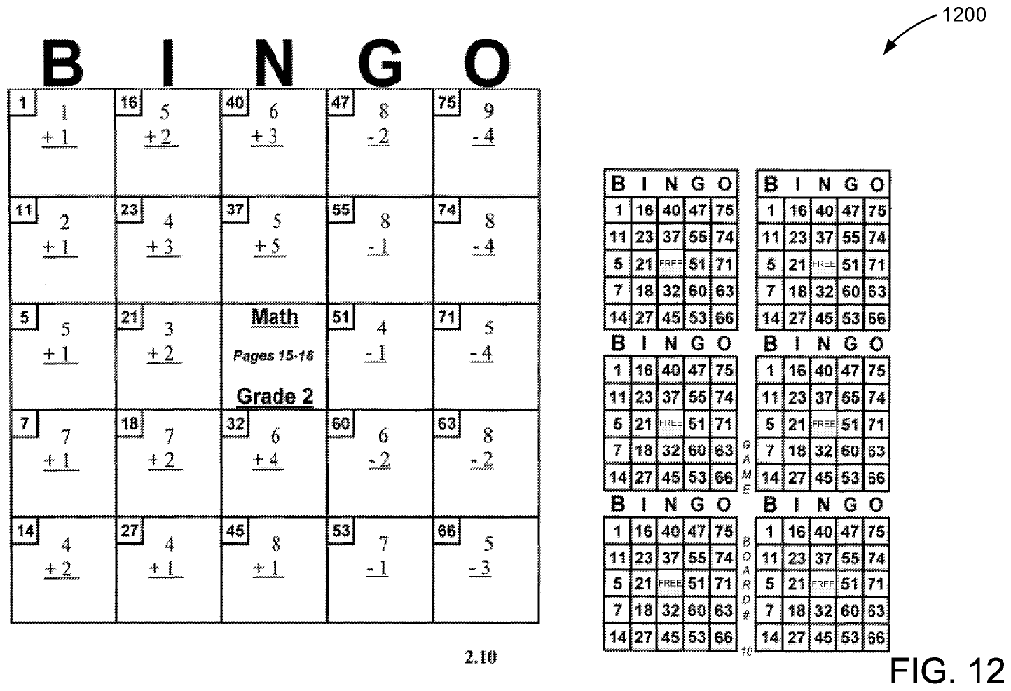

FIG. 12 is an example illustration 1200 of educational material 450 (shown in FIG. 4) generated by system 100 (shown in FIG. 1). Illustration 1200 is in the game format where the teacher use the difference numbered squares to have the students fill in answers. After the student has answered the problems or questions then the students can keep track of the difference numbers called out in the game BINGO by any one of the numbered grids to the right side of the sheet.

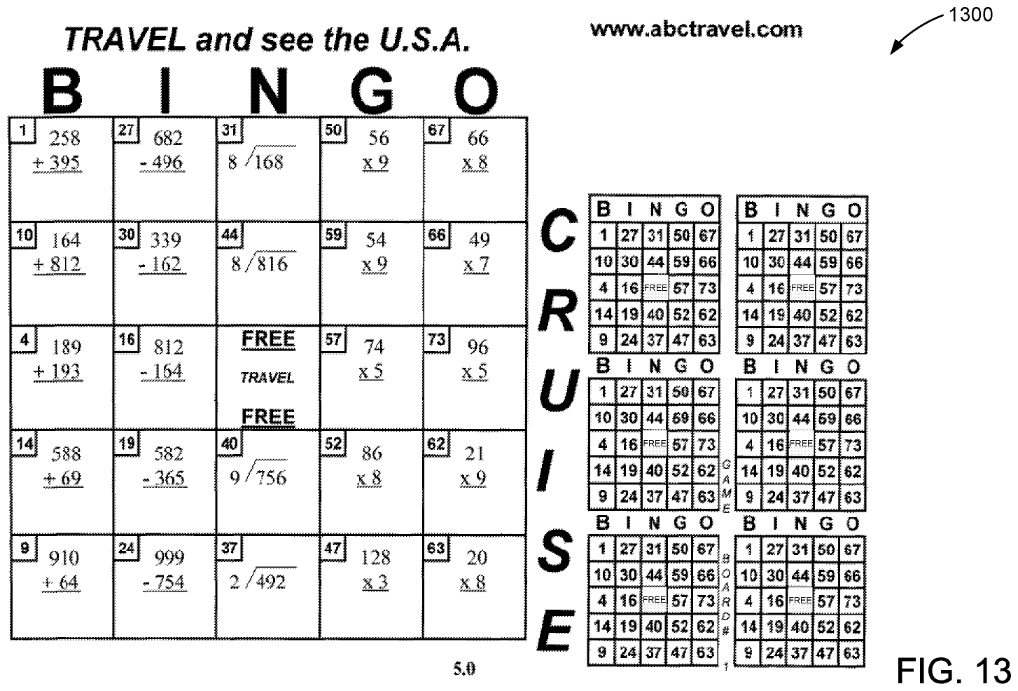

FIG. 13 is an example illustration 1300 of educational material 450 (shown in FIG. 4) generated by system 100 (shown in FIG. 1). Illustration 1300 is in the game format like FIG. 12 but shows where a company could advertise its service or products while the game is being played.

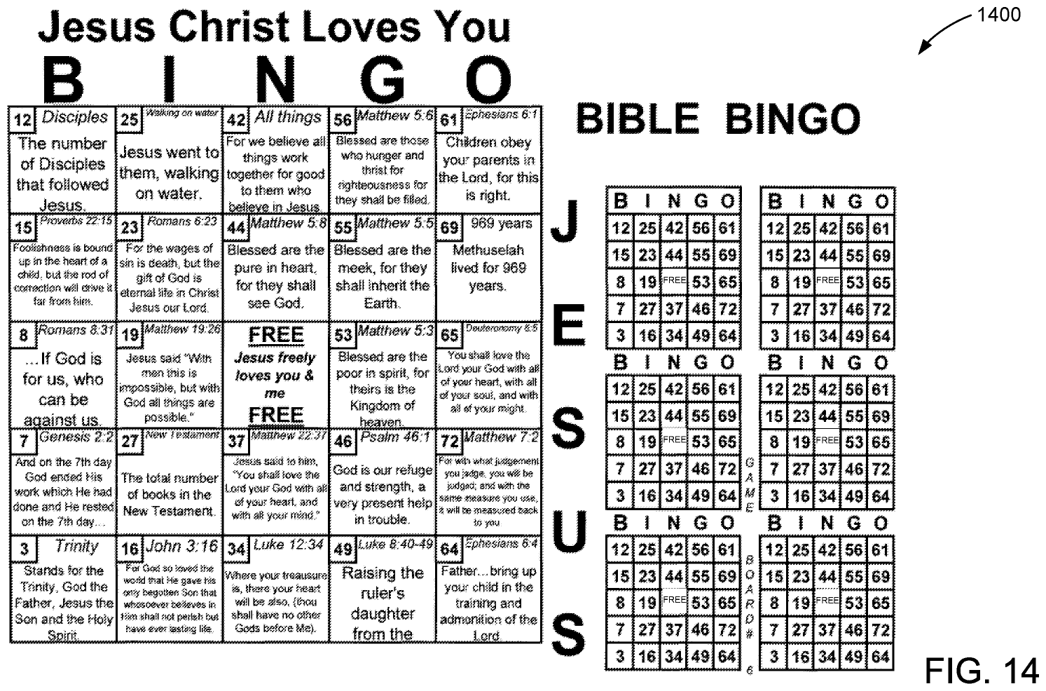

FIG. 14 is an example illustration 1400 of educational material 450 (shown in FIG. 4) generated by system 100 (shown in FIG. 1). Illustration 1400 is in the game format where the teacher use the difference numbered squares to review difference Bible scripture as they call out difference numbers. The students can keep track of the difference numbers called out in the game BINGO by any one of the numbered grids to the right side of the sheet.

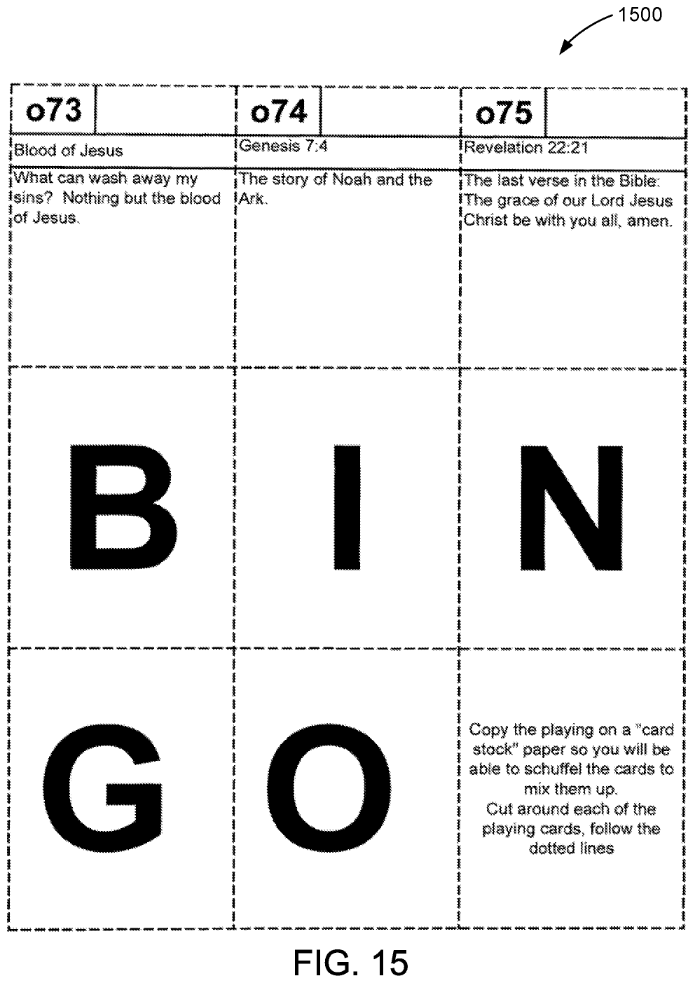

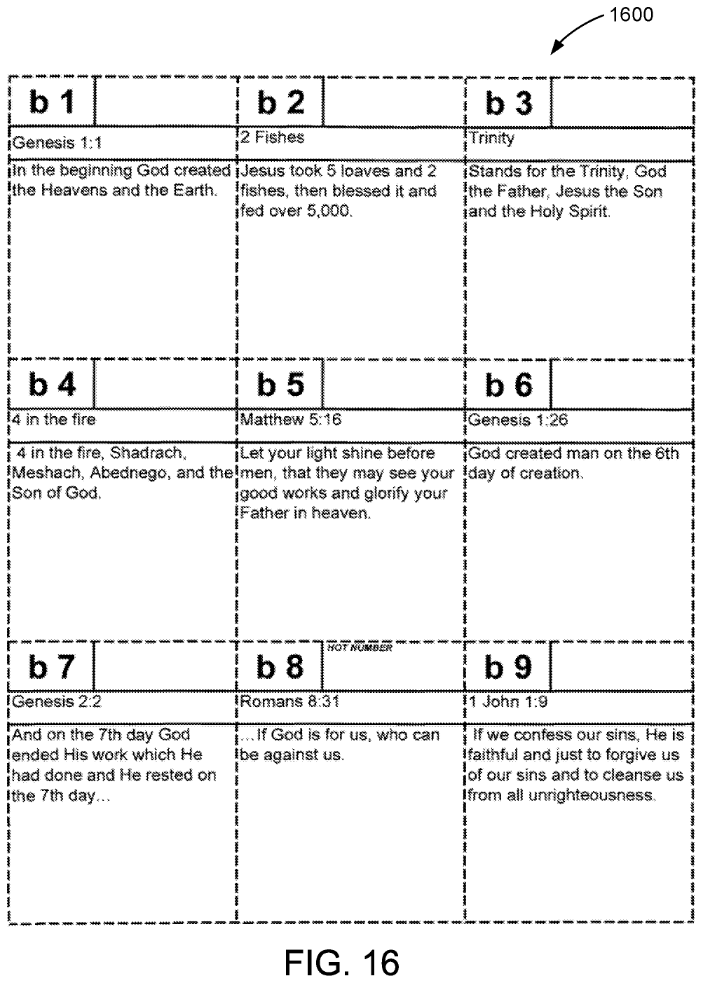

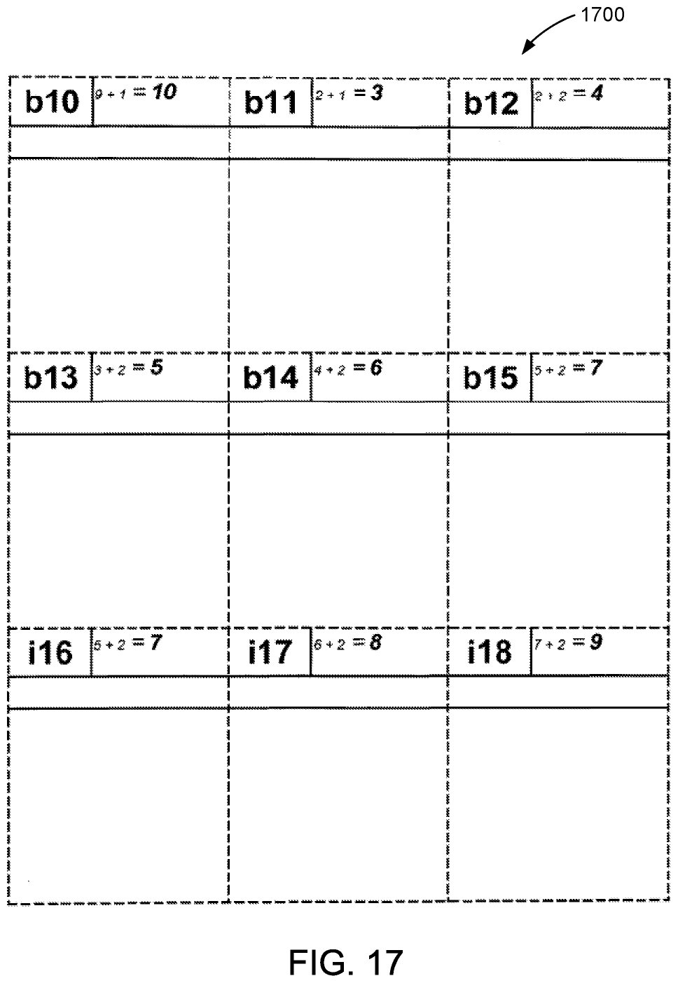

FIGS. 15-17 are an example illustrations 1500, 1600, and 1700 of educational material 450 (shown in FIG. 4) generated by system 100 (shown in FIG. 1). Illustrations 1500, 1600, and 1700 are inteacher formats that the teacher uses to shuffle and keep track of the difference BINGO numbers called out. The teacher will typically copy these on “card stock” paper so that the numbers will be like a deck of cards. The letters BINGO is placed on their table to easily keep track of the numbers called out. Once a student gets BINGO then it's easy to check if the numbers were called out and any answer to the problems. Teacher cards can be condense to one or two sheets to help with grading of the difference boards in homework or test format or could be automatic if tablet are being used by the students.

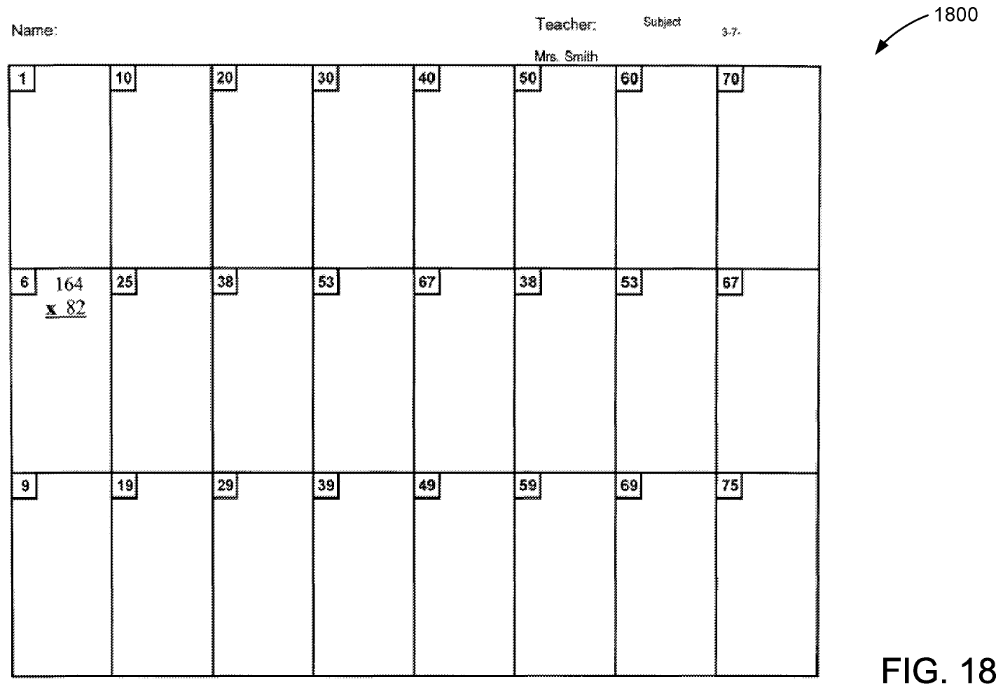

FIG. 18 is an example illustration 1800 of educational material 450 (shown in FIG. 4) generated by system 100 (shown in FIG. 1). Illustration 1800 is in the homework or test format where the teacher use the difference numbered squares to have the students fill in answers to the questions the squares are longer for space to answer the problems. The extra space is helpful so the teacher can follow how the student comes up with their answers.

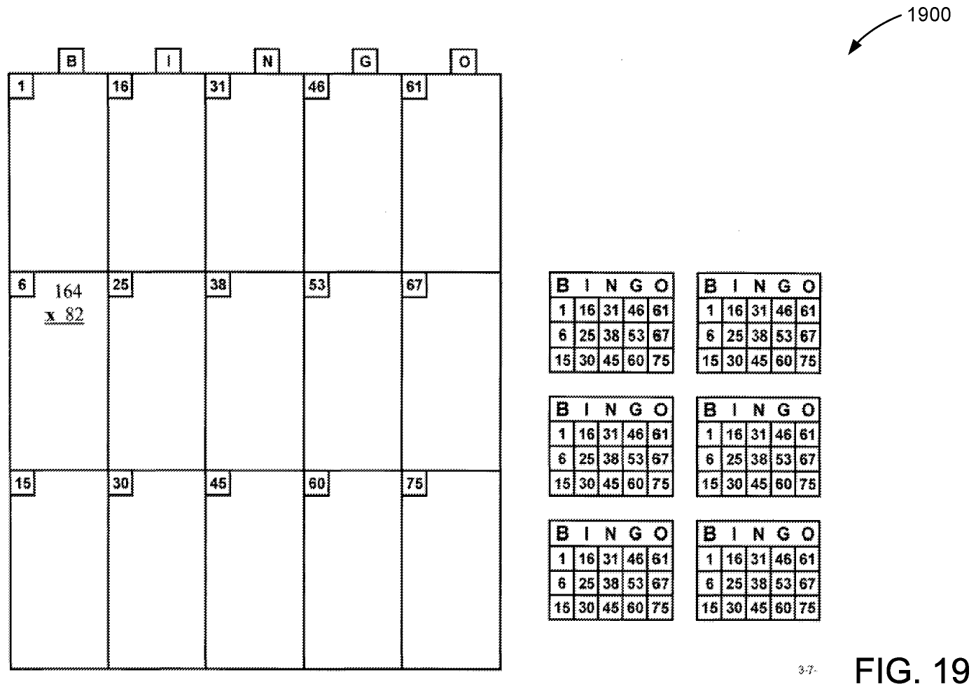

FIG. 19 is an example illustration 1900 of educational material 450 (shown in FIG. 4) generated by system 100 (shown in FIG. 1). Illustration 1900 is in the game format with the longer squares where the teacher use the difference numbered squares to have the students fill in answers. After the student has answered the problems or questions then the students can keep track of the difference numbers called out in the game BINGO by any one of the numbered grids to the right side of the sheet. With the longer format the only way to win is to have the numbers connect down or across.

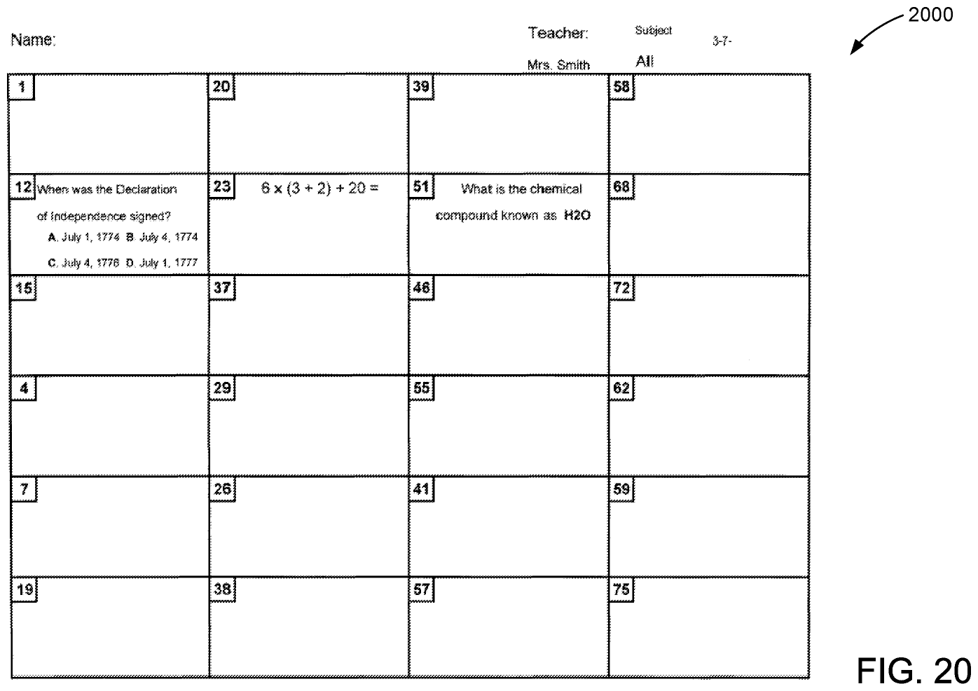

FIG. 20 is an example illustration 2000 of educational material 450 (shown in FIG. 4) generated by system 100 (shown in FIG. 1). Illustration 2000 is in the homework or test format where the teacher use the difference numbered squares to have the students fill in answers to the questions the squares are wider for space to answer the problems. The extra space is helpful so the teacher can follow how the student comes up with their answers.

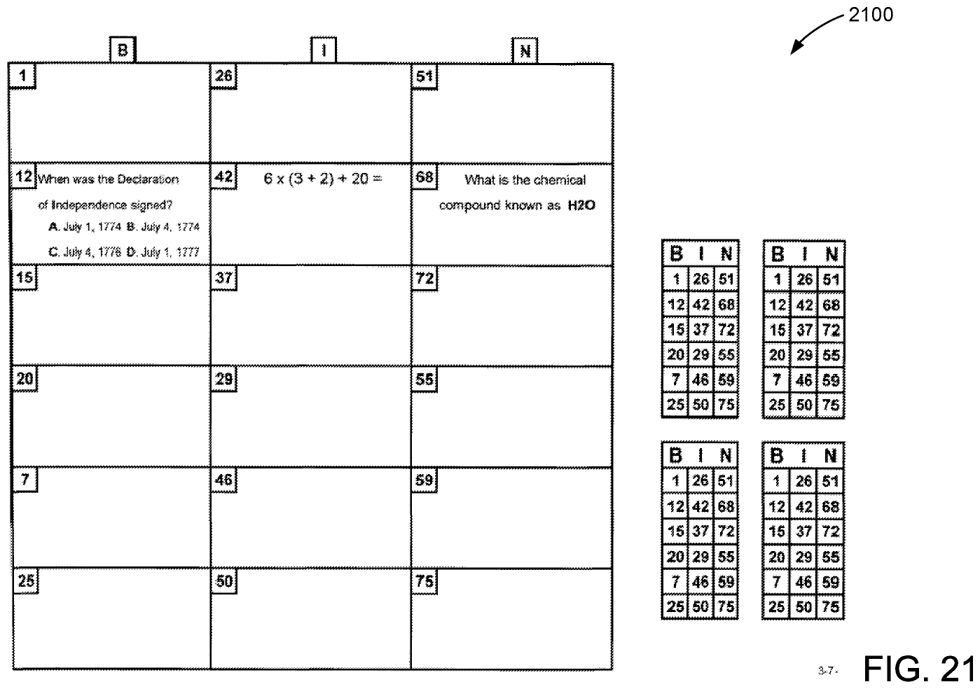

FIG. 21 is an example illustration 2100 of educational material 450 (shown in FIG. 4) generated by system 100 (shown in FIG. 1). Illustration 2100 is in the game format with the wider squares where the teacher use the difference numbered squares to have the students fill in answers. After the student has answered the problems or questions then the students can keep track of the difference numbers called out in the game BINGO by any one of the numbered grids to the right side of the sheet. With the wider format the only way to win is to have the numbers connect down or across.

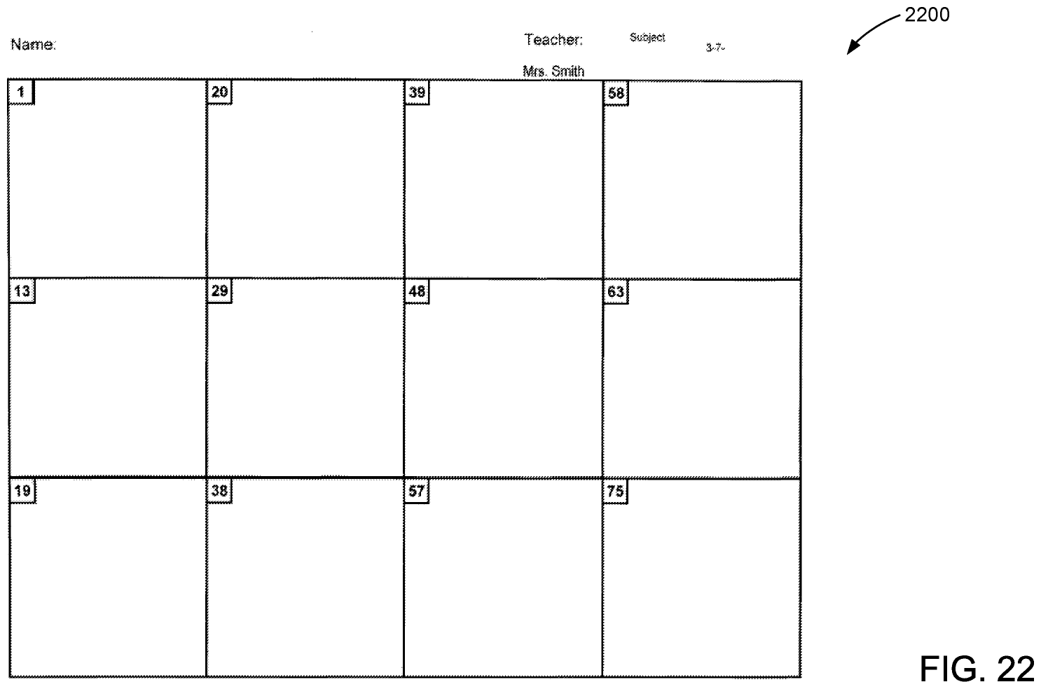

FIG. 22 is an example illustration 2200 of educational material 450 (shown in FIG. 4) generated by system 100 (shown in FIG. 1). Illustration 2200 is in the homework or test format where the teacher use the difference numbered squares to have the students fill in answers to the questions the squares are bigger for space to answer the problems. The extra space is helpful so the teacher can follow how the student comes up with their answers.

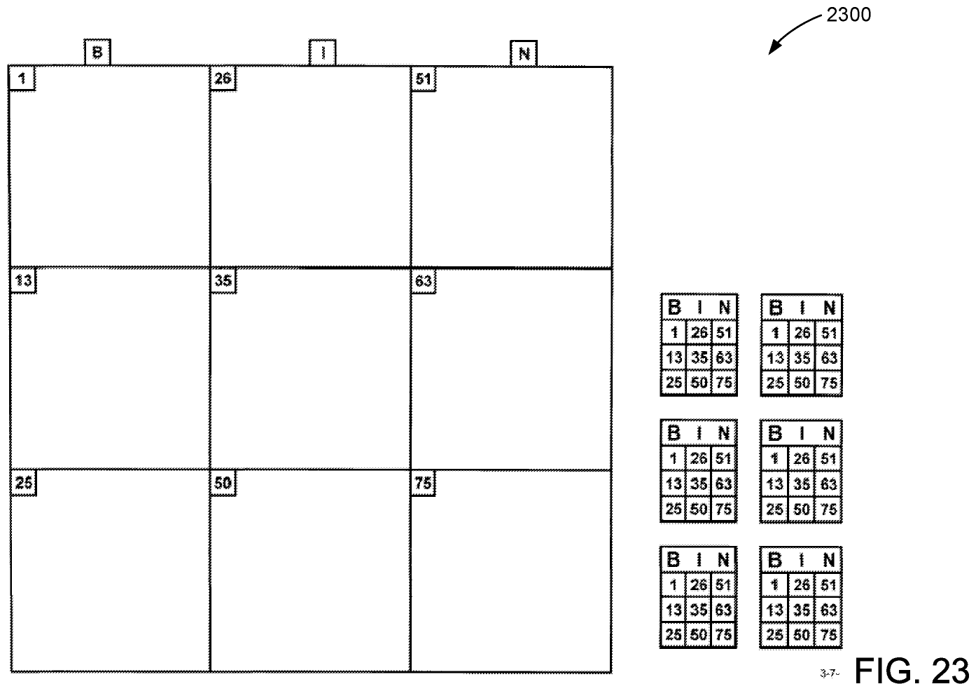

FIG. 23 is an example illustration 2300 of educational material 450 (shown in FIG. 4) generated by system 100 (shown in FIG. 1). Illustration 2300 is in the game format with the bigger squares where the teacher use the difference numbered squares to have the students fill in answers. After the student has answered the problems or questions then the students can keep track of the difference numbers called out in the game BINGO by any one of the numbered grids to the right side of the sheet.

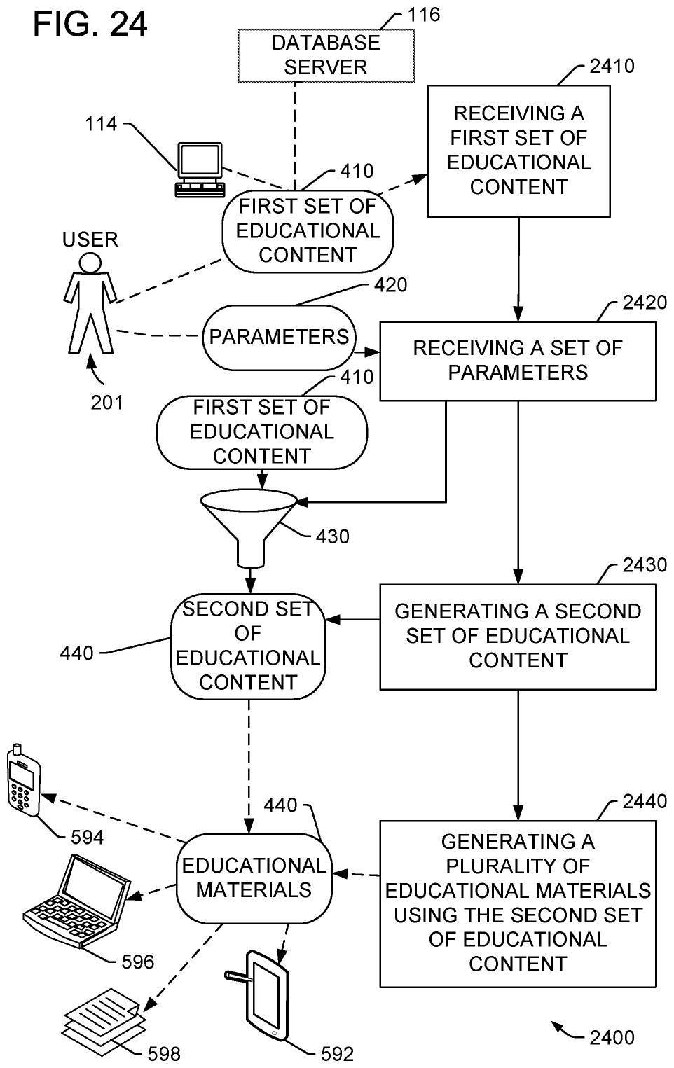

FIG. 24 is a flowchart illustrating an example process 2400 utilized by system 100 (shown in FIG. 1) for generating educational materials 450. Initially, server 112 receives 2410 a first set of educational content. Receiving 2410 represents receiving first set of educational content 410 from at least one of database server 116, user 201, educational content data file 401 (shown in FIG. 4), and client 114. First set of educational content 410 is received at memory device 310 (shown in FIG. 3).

Server 112 receives 2420 a set of parameters. Receiving 2420 represents receiving parameters 420 from at least one of user 201, client 114, or educational content data file 401.

Server 112 additionally generates 2430 a second set of educational content by applying the set of parameters to the first set of educational content. Generating 2430 represents creating second set of educational content 440 by applying set of parameters 420 to first set of educational content 410.

Server 112 finally generates 2440 a plurality of educational materials using the second set of educational content. Generating 2440 represents creating educational materials 450 using second set of educational content 440. In some examples, generating 2440 also includes applying format requirements received in, for example, parameters 420.

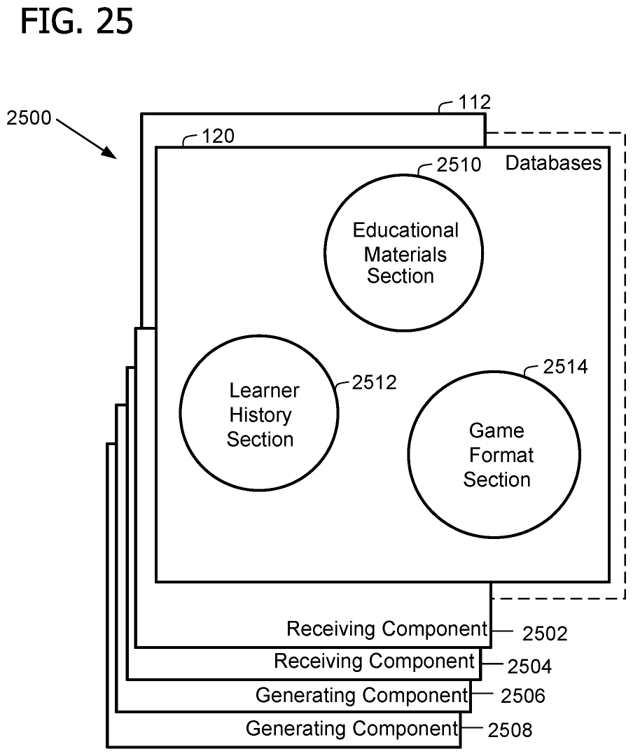

FIG. 25 is a diagram 2500 of components of one or more example computing devices, for example server 112, which may be used in the environment shown in FIG. 5. FIG. 25 further shows a configuration of databases including at least database 120 (shown in FIG. 1). Database 120 is coupled to several separate components within server 112, which perform specific tasks.

Server 112 includes a receiving component 2502 for receiving a first set of educational content 410 (shown in FIG. 4). Server 112 also includes a receiving component 2504 for receiving a set of parameters 420 (shown in FIG. 4). Server 112 additionally includes a generating component 2506 for generating a second set of educational content 440 (shown in FIG. 4) by applying the set of parameters 420 to the first set of educational content 410. Server 112 additionally includes a generating component 2508 generating a set of educational materials 450 based upon the second set of educational content 440.

In an exemplary embodiment, database 120 is divided into a plurality of sections, including but not limited to, an educational materials section 2510, a learner history section 2512, and a game format section 2514. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computing device for dynamically generating customized educational materials using heuristic and natural language processing algorithms, said computing device including a processor and a memory device coupled to said processor, said computing device configured to:
receive, from at least one of a database server, an educational content data file, and a client computing device, a first set of educational content including a plurality of educational questions and a plurality of educational answers, wherein each educational answer is associated with at least one of the plurality of educational questions;
generate a first set of educational content metadata by applying at least one of natural language processing algorithms and heuristic algorithms to the first set of educational content, the first set of educational content metadata including a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content;
store the first set of educational content metadata within the memory device along with the first set of educational content;
receive, from at least one of the database server, the educational content data file, and the client computing device, a set of parameters including a format parameter for generating an output format of a plurality of educational materials;
generate a filter based on the set of parameters, the filter representing an algorithm used for parsing the first set of educational content to generate a second set of educational content, the second set of educational content including a second set of educational content metadata matching the set of parameters used to generate the filter; and
generate the plurality of educational materials using the second set of educational content including generating at least one game board based on the format parameter.

2. The computing device of claim 1, wherein the set of parameters includes at least one of a difficulty level, a grade level, a categorization level, a subject level, an age level, a usage history, a school week number, and a total number of users.

3. The computing device of claim 1 further configured to generate the second set of educational content by:
sorting the second set of educational content, the second set of educational content representing a plurality of groups of the educational questions and a sorted set of the educational answers; and
digitally displaying, on a plurality of client computing devices each associated with a learner, the plurality of educational materials using the second set of educational content including displaying the generated at least one game board.

4. The computing device of claim 1, wherein the format parameter specifies the plurality of educational materials be formatted in a bingo format, and wherein generating the plurality of educational materials further comprises:
generating a first bingo game board, the first bingo game board including a first matrix having a first plurality of cells, at least some of the first plurality of cells including educational questions from the second set of educational content;
generating a second bingo game board that is different from the first bingo game board, the second bingo game board including a second matrix having a second plurality of cells, at least some of the second plurality of cells including educational questions from the second set of educational content;
transmitting the first bingo game board to a first client computing device to cause the first bingo game board to be displayed on the first client computing device; and
transmitting the second bingo game board to a second client computing device to cause the second bingo game board to be displayed on the second client computing device.

5. The computing device of claim 4, wherein the first client computing device is associated with a first user and the second client computing device is associated with a second user.

6. The computing device of claim 1 further configured to:
parse, using the generated filter, the first set of educational content based on the first set of educational content metadata; and
generate, based on the parsing, the second set of educational content.

7. The computing device of claim 6, wherein generating the second set of educational content further comprises generating at least one of:
a plurality of educational cards based upon a plurality of groups of the educational questions, wherein the plurality of educational cards are formatted in a matrix layout;
a sorted set of the educational answers and associated educational questions; and
supplementary educational material associated with the second set of educational content, wherein the supplementary educational material contains references associating educational questions to portions of the supplementary educational material.

8. A computer-based method for dynamically generating customized educational materials using heuristic and natural language processing algorithms, the method implemented by a computing device including a processor and a memory device coupled to the processor, the method comprising:
receiving, from at least one of a database server, an educational content data file, and a client computing device, a first set of educational content including a plurality of educational questions and a plurality of educational answers, wherein each educational answer is associated with at least one of the plurality of educational questions;
generating a first set of educational content metadata by applying at least one of natural language processing algorithms and heuristic algorithms to the first set of educational content, the first set of educational content metadata including a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content;
storing the first set of educational content metadata within the memory device along with the first set of educational content;
receiving, from at least one of the database server, the educational content data file, and the client computing device, a set of parameters including a format parameter for generating an output format of a plurality of educational materials;
generating a filter based on the set of parameters, the filter representing an algorithm used for parsing the first set of educational content to generate a second set of educational content, the second set of educational content including a second set of educational content metadata matching the set of parameters used to generate the filter; and
generating the plurality of educational materials using the second set of educational content including generating at least one game board based on the format parameter.

9. The computer-based method of claim 8, wherein the set of parameters includes at least one of a difficulty level, a grade level, a categorization level, a subject level, an age level, a usage history, a school week number, and a total number of users.

10. The computer-based method of claim 8, wherein generating the second set of educational content further comprises:
sorting the second set of educational content, the second set of educational content representing a plurality of groups of the educational questions and a sorted set of the educational answers; and
digitally displaying, on a plurality of client computing devices each associated with a learner, the plurality of educational materials using the second set of educational content including displaying the generated at least one game board.

11. The computer-based method of claim 8, wherein the format parameter specifies the plurality of educational materials be formatted in a bingo format, and wherein generating the plurality of educational materials further comprises:
generating a first bingo game board, the first bingo game board including a first matrix having a first plurality of cells, at least some of the first plurality of cells including educational questions from the second set of educational content;
generating a second bingo game board that is different from the first bingo game board, the second bingo game board including a second matrix having a second plurality of cells, at least some of the second plurality of cells including educational questions from the second set of educational content;
transmitting the first bingo game board to a first client computing device to cause the first bingo game board to be displayed on the first client computing device; and
transmitting the second bingo game board to a second client computing device to cause the second bingo game board to be displayed on the second client computing device.

12. The computer-based method of claim 11, wherein the first client computing device is associated with a first user and the second client computing device is associated with a second user.

13. The computer-based method of claim 8 further comprising:
parsing, using the generated filter, the first set of educational content based on the first set of educational content metadata; and
generating, based on the parsing, the second set of educational content.

14. The computer-based method of claim 13, wherein generating the second set of educational content further comprises generating at least one of:
a plurality of educational cards based upon a plurality of groups of the educational questions, wherein the plurality of educational cards are formatted in a matrix layout;
a sorted set of the educational answers and associated educational questions; and
supplementary educational material associated with the second set of educational content, wherein the supplementary educational material contains references associating educational questions to portions of the supplementary educational material.

15. One or more non-transitory computer-readable storage media for dynamically generating customized educational materials using heuristic and natural language processing algorithms, the one or more non-transitory computer-readable storage media having computer-executable instructions embodied thereon, wherein when executed by at least one computing device having a processor and a memory device coupled to the processor, the computer-executable instructions cause the at least one computing device to:
receive, from at least one of a database server, an educational content data file, and a client computing device, a first set of educational content including a plurality of educational questions and a plurality of educational answers, wherein each educational answer is associated with at least one of the plurality of educational questions;
generate a first set of educational content metadata by applying at least one of natural language processing algorithms and heuristic algorithms to the first set of educational content, the first set of educational content metadata including a difficulty rating associated with each of the plurality of educational questions and answers of the first set of educational content, a subject matter category associated with each of the plurality of educational questions and answers of the first set of educational content, an age level associated with each of the plurality of educational questions and answers of the first set of educational content, and a usage history associated with each of the plurality of educational questions and answers of the first set of educational content;
store the first set of educational content metadata within the memory device along with the first set of educational content;
receive, from at least one of the database server, the educational content data file, and the client computing device, a set of parameters including a format parameter for generating an output format of a plurality of educational materials;
generate a filter based on the set of parameters, the filter representing an algorithm used for parsing the first set of educational content to generate a second set of educational content, the second set of educational content including a second set of educational content metadata matching the set of parameters used to generate the filter; and
generate the plurality of educational materials using the second set of educational content including generating at least one game board based on the format parameter.

16. The non-transitory computer-readable storage media of claim 15, wherein the set of parameters includes at least one of a difficulty level, a grade level, a categorization level, a subject level, an age level, a usage history, a school week number, and a total number of users.

17. The non-transitory computer-readable storage media of claim 15, wherein the computer-executable instructions further cause the at least one computing device to generate the second set of educational content by:
sorting the second set of educational content, the second set of educational content representing a plurality of groups of the educational questions and a sorted set of the educational answers; and
digitally displaying, on a plurality of client computing devices each associated with a learner, the plurality of educational materials using the second set of educational content including displaying the generated at least one game board.

18. The non-transitory computer-readable storage media of claim 15, wherein the format parameter specifies the plurality of educational materials be formatted in a bingo format, and wherein generating the plurality of educational materials further comprises:
generating a first bingo game board, the first bingo game board including a first matrix having a first plurality of cells, at least some of the first plurality of cells including educational questions from the second set of educational content;
generating a second bingo game board that is different from the first bingo game board, the second bingo game board including a second matrix having a second plurality of cells, at least some of the second plurality of cells including educational questions from the second set of educational content;
transmitting the first bingo game board to a first client computing device to cause the first bingo game board to be displayed on the first client computing device; and
transmitting the second bingo game board to a second client computing device to cause the second bingo game board to be displayed on the second client computing device.

19. The non-transitory computer-readable storage media of claim 15, wherein the computer-executable instructions further cause the at least one computing device to:
parse, using the generated filter, the first set of educational content based on the first set of educational content metadata; and
generate, based on the parsing, the second set of educational content.

20. The non-transitory computer-readable storage media of claim 19, wherein generating the second set of educational content further comprises generating at least one of:
a plurality of educational cards based upon a plurality of groups of the educational questions, wherein the plurality of educational cards are formatted in a matrix layout;
a sorted set of the educational answers and associated educational questions; and
supplementary educational material associated with the second set of educational content, wherein the supplementary educational material contains references associating educational questions to portions of the supplementary educational material.
